(19) United States
(12) Patent Application Publication
(10) Pub. No.: US 2011/0164249 A1
(43) Pub. Date: Jul. 7, 2011

(54) LIGHT SPECTRUM DETECTION METHOD

(75) Inventors: Takeharu INNAMI, Tokyo (JP); Kenji TAIRA, Tokyo (JP); Hiroyoshi YAJIMA, Sagamihara-shi (JP); Hiroya FUKUYAMA, Tokyo (JP); Mitsuru NAMIKI, Hannou-shi (JP); Makoto IGARASHI, Tokyo (JP); Shunji TAKEI, Tokyo (JP)

(73) Assignee: OLYMPUS CORPORATION, Tokyo (JP)

(21) Appl. No.: 12/939,495

(22) Filed: Nov. 4, 2010

(30) Foreign Application Priority Data
Nov. 4, 2009 (JP) JP 2009-252959

(51) Int. Cl. G01J 3/28

(52) U.S. Cl. 356/326

(57) ABSTRACT

Optical spectrum of a light irradiated on the object, a spontaneous light emitted from within the object or a surface thereof, a scattered light, a transmitted light, a reflected light or a refracted light from within the object or a surface thereof generated by irradiating light on the object is resolved by amplifying said lights in a bandwidth narrower than the bandwidth of the optical spectrum of said lights. Thus, a method for detecting optical spectrum is provided in which signal intensity is amplified while deterioration of spectral data is suppressed.

### CROSS REFERENCE TO RELATED APPLICATIONS

The present application claims priority from Japanese Application No. 2009-252959, filed on Nov. 4, 2009, the content of which is incorporated herein by reference.

### TECHNICAL FIELD

The present invention relates to a method for obtaining spectroscopic data from an object and displaying or analyzing a form or function within or surface of the object from the obtained data.

### BACKGROUND OF THE INVENTION

For example, Japanese Unexamined Patent Application Publication No. 1998-309282 discloses a fluorescence observation device which performs accurate tissue characterization by using intensity of autofluorescence of the tissue. In this fluorescence observation device, a dark image, caused by extracting specific range of wavelengths, is brightened by extracting a certain wavelength range by means of a band pass filter dispersing fluorescence from a biological body and an image intensifier for amplifying a fluorescent image.

In spectrometry of a biological body such as autofluorescence observation, it is a problem that intensity of a detected signal may be weaken due to extraction of a certain wavelength range. Therefore, it is difficult to narrow a wavelength range of extraction in order to improve a contrast of an image or a possibility of selecting fluorescence materials. The above problem with respect to the detection signal can be solved by amplifying light to improve S/N ratio. However, in the fluorescence observation device disclosed in JP 1998309282A, it is not possible to obtain an image with good S/N ratio due to additive noise caused by the amplification of the fluorescence image using the image intensifier in an electron amplification process. Moreover, it is not possible to obtain an image with good N/S ratio without using a filter with high extinction factor, since the wavelength range is extracted only by a band pass filter. In view of this point, a method for amplifying signal intensity while suppressing deterioration of the spectroscopic data is provided according to the invention.

### SUMMARY OF THE INVENTION

The first aspect of the invention of a method for detecting optical spectrum, which achieves the object described above, is characterized in that the optical spectrum of a light irradiated on an object, a spontaneous light emitted from within the object or a surface thereof, a scattered light, a transmitted light, a reflected light or a refracted light from within the object or a surface thereof generated by irradiating light on the object are resolved by amplifying said lights in a bandwidth narrower than the bandwidth of optical spectrum of said lights.

The second aspect of the invention of the method for detecting optical spectrum is characterized in that the object is irradiated with the light amplified in the bandwidth narrower than the bandwidth of the optical spectrum of a light source; and the optical spectrum of the scattered light, the transmitted light, the reflected light or the refracted light from within the object or the surface thereof generated by irradiating light on the object is resolved and detected at a photoelectric converter.

The third aspect of the invention of the method for detecting optical spectrum is characterized in that the light spectrum of the scattered light, the transmitted light, the reflected light or the refracted light from within the object or the surface thereof generated by irradiating light on the object is resolved by amplifying said lights in a bandwidth narrower than the bandwidth of the optical spectrum of said lights and detected at the photoelectric converter.

The fourth aspect of the invention of the method for detecting optical spectrum is characterized in that the light spectrum of the spontaneous light irradiated from within the object or a surface thereof is resolved by amplifying said light in the bandwidth narrower than bandwidth of the optical spectrum of said light and detected at the photoelectric converter.

The fifth aspect of the invention of the method for detecting optical spectrum is characterized in that the object is irradiated with the light amplified in the bandwidth narrower than the bandwidth of the optical spectrum of a light source; and the optical spectrum of the scattered light, the transmitted light, the reflected light or the refracted light from within the object or the surface thereof generated by irradiating light on the object is resolved by amplifying said lights in the bandwidth narrower than the bandwidth of the optical spectrum of said lights and detected at a photoelectric converter.

The sixth aspect of the invention of the method for detecting optical spectrum is characterized in that the light spectrum of the scattered light, the transmitted light, the reflected light or the refracted light from within the object or the surface thereof generated by irradiating light on the object is resolved by extracting a wavelength of said lights by means of a filter and detected at a photoelectric converter.

The seventh aspect of the invention of the method for detecting optical spectrum is characterized in that a wavelength of the light from the light source is extracted by the filter and the light with the extracted wavelength is irradiated on the object.

The eighth aspect of the invention of the method for detecting optical spectrum is characterized in that the wavelength of the amplified light is extracted by means of a filter and the light with the extracted wavelength is irradiated on the object or detected at the photoelectric converter.

The ninth aspect of the invention of the method for detecting optical spectrum is characterized in that the light irradiated on the object, the spontaneous light emitted from within the object or the surface thereof, the scattered light, the transmitted light, the reflected light or the refracted light from within the object or the surface thereof generated by irradiating light on the object is amplified after adjusting a mode.

According to the first aspect of the invention of a method for detecting optical spectrum, the optical spectrum of a light irradiated on the object, a spontaneous light emitted from within the object or a surface thereof, a scattered light, a transmitted light, a reflected light or a refracted light from within the object or a surface thereof generated by irradiating light on the object are resolved by amplifying said lights in a bandwidth narrower than the bandwidth of optical spectrum of said lights, so that even a light with weak intensity due to the narrowed bandwidth can be amplified and detected rapidly with low noise.

According to the second aspect of the invention of the method for detecting optical spectrum, the object is irradiated with the light amplified in the bandwidth narrower than the bandwidth of the optical spectrum of a light source; and the optical spectrum of the scattered light, the transmitted light, the reflected light or the refracted light from within the object or the surface thereof generated by irradiating light on the object is resolved and detected at a photoelectric converter, so that even a light with weak intensity due to the narrowed bandwidth can be amplified and a light source with a narrow bandwidth with enough intensity can be realized.

According to the third aspect of the invention of the method for detecting optical spectrum, that the light spectrum of the scattered light, the transmitted light, the reflected light or the refracted light from within the object or the surface thereof generated by irradiating light on the object is resolved by amplifying said lights in a bandwidth narrower than the bandwidth of the optical spectrum of said lights and detected at the photoelectric converter, so that even a light with weak intensity due to the narrowed bandwidth can be amplified and the light can detected rapidly with low noise relative to a case of using only a photoelectric converter.

According to the fourth aspect of the invention of the method for detecting optical spectrum, the light spectrum of the spontaneous light irradiated from within the object or a surface thereof is resolved by amplifying said light in the bandwidth narrower than the bandwidth of the optical spectrum of said light and detected at the photoelectric converter, so that even a light with weak intensity due to the narrowed bandwidth can be amplified and a luminescence of a biological body and the like can be detected rapidly with low noise.

According to the fifth aspect of the invention of the method for detecting optical spectrum, the object is irradiated with the light amplified in the bandwidth narrower than the bandwidth of the optical spectrum of a light source; and the optical spectrum of the scattered light, the transmitted light, the reflected light or the refracted light from within the object or the surface thereof generated by irradiating light on the object is resolved by amplifying said lights in the bandwidth narrower than the bandwidth of the optical spectrum of said lights and detected at a photoelectric converter, so that amplification effect of the light with weak intensity due to the narrowed bandwidth is further improved and the decrease of the intensity of the light to be detected is suppressed.

According to the sixth aspect of the invention of the method for detecting optical spectrum, the light spectrum of the scattered light, the transmitted light, the reflected light or the refracted light from within the object or the surface thereof generated by irradiating light on the object is resolved by extracting a wavelength of said lights by means of a filter and detected at a photoelectric converter, so that the optical spectrum can be detected with high wavelength resolution.

According to the seventh aspect of the invention of the method for detecting optical spectrum, a wavelength of the light from the light source is extracted by the filter and the light with the extracted wavelength is irradiated on the object, so that the light having a spectrum except for the wavelength range of the light to be detected is not detected, and thus the light can be detected with low noise.

According to the eighth aspect of the invention of the method for detecting optical spectrum, the wavelength of the amplified light is extracted by means of a filter and the light with the extracted wavelength is irradiated on the object or detected at the photoelectric converter, so that noisy light such as ASE generated by amplifying light can be blocked, and thus the light can be detected with low noise.

According to the ninth aspect of the invention of the method for detecting optical spectrum, the light irradiated on the object, the spontaneous light emitted from within the object or the surface thereof, the scattered light, the transmitted light, the reflected light or the refracted light from within the object or the surface thereof generated by irradiating light on the object is amplified after adjusting a mode, so that even a light detected with scattering or a disturbed waveform can be collected with high efficiency, and thus the light can be detected rapidly with high sensitivity.

### BRIEF DESCRIPTION OF THE DRAWINGS

FIG. 1 is a block diagram showing a schematic configuration of an endoscope device according to the first embodiment of the invention;

FIG. 2 is a plan view showing a configuration of a frame sequential filter in the endoscope device according to the first embodiment of the invention;

FIG. 3 is a plan view showing a configuration of an optical amplification unit of the endoscope device according to the first embodiment of the invention;

FIG. 4A and FIG. 4B are a top view and a side view, respectively, of the optical amplifier of the endoscope device according to the first embodiment of the invention;

FIG. 5 is a graph showing a spectral property of the endoscope device according to the first embodiment of the invention;

FIG. 6 is a block diagram showing a schematic configuration of the endoscope device according to the second embodiment of the invention;

FIGS. 7A and 7B are a top view and a side view, respectively, of an optical amplifier of the endoscope device according to the second embodiment of the invention;

FIG. 8 a graph showing a spectral property of the endoscope device according to the second embodiment of the invention;

FIG. 9 shows a block diagram showing schematic configuration of the endoscope device according to the third embodiment of the invention;

FIG. 10A and FIG. 10B are a top view and a side view, respectively, of the optical amplifier of the endoscope device according to the third embodiment of the invention;

FIG. 11 is a graph showing a spectral property of the endoscope device according to the third embodiment of the invention;

FIG. 12 a block diagram showing a schematic configuration of the scanning endoscope device according to the fourth embodiment of the invention;

FIG. 13A is and FIG. 13B are a top view and a side view, respectively, showing a configuration of the optical amplifier of the scanning endoscope device according to the fourth embodiment of the invention;

FIG. 14 is a block diagram showing a schematic configuration of the scanning fluorescence microscope device according to the fifth embodiment of the invention;

FIGS. 15A and 15B are a top view and a side view, respectively, of an exemplary configuration of the optical amplifier of the scanning fluorescence microscope device according to the fifth embodiment of the invention; and

FIG. 16 is a graph showing a spectral property of the optical amplifier of the scanning fluorescence microscope device according to the fifth embodiment of the invention.

### DESCRIPTION OF THE PREFERRED EMBODIMENTS

Embodiments of the present invention will be now described with reference to the accompanying drawings.

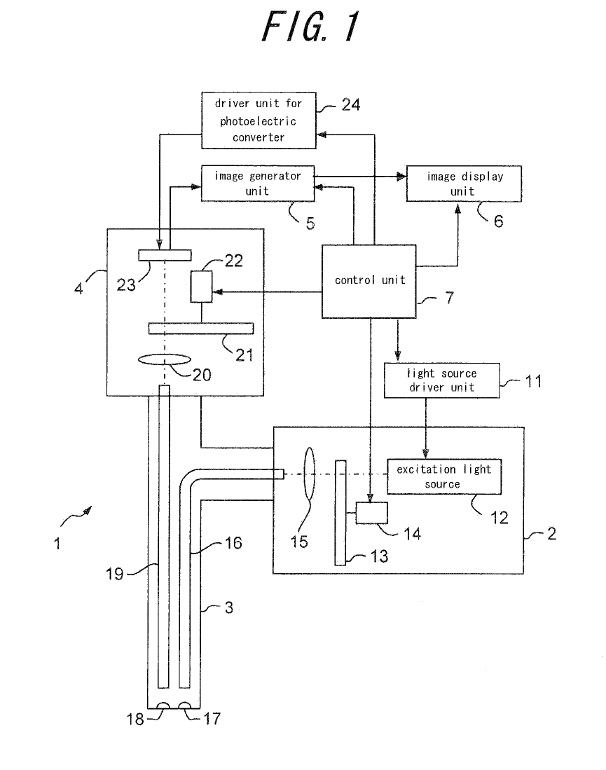

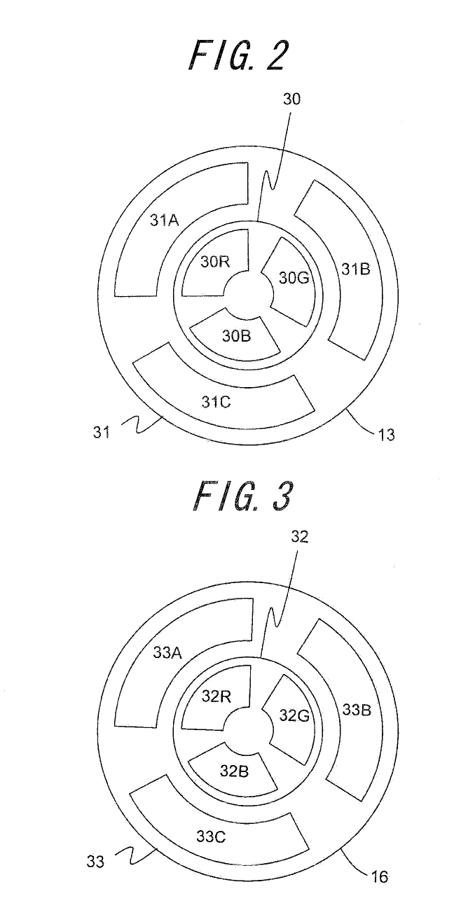

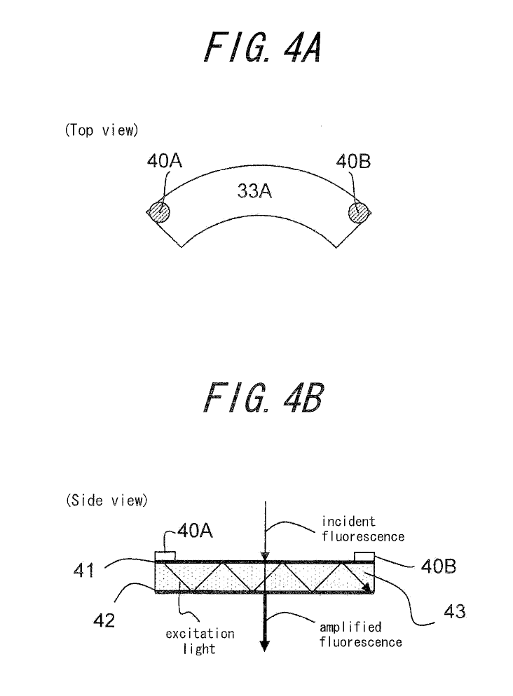

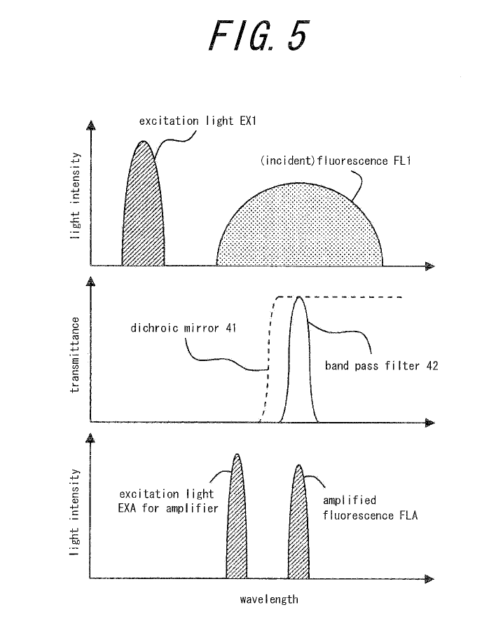

The first embodiment: Referring to FIGS. 1 to 5, the first embodiment of a method for detecting an optical spectrum is described. The method for detecting the optical spectrum in an endoscope device is provided. However, the invention is not limited to this, but applicable in otherwise. FIGS. 1 to 4 are related to the first embodiment. FIG. 1 is a block diagram showing a schematic configuration of an endoscope device, FIG. 2 is a plan view showing a configuration of a frame sequential filter, FIG. 4A is a top view of a configuration of an optical amplifier, FIG. 4B is a side view of a configuration of the optical amplifier, and FIG. 5 is a graph showing spectral property of a light source device and an optical amplifier unit for fluorescence observation.

Configuration: As shown in FIG. 1, the endoscope device 1 according to the first embodiment comprises a main part unit having a light source device 2, an insertion unit 3, an optical detection device 4, an image generator unit 5, an image display unit 6 and a control unit 7.

An excitation light source 12 and a frame sequential filter 13 are integrated into the light source device 2. The excitation light source 12 is connected to a light source driver unit 11 and is driven by electric current generated at the light source driver unit 11. The light guide 16, the illumination lens 17, the objective lens 18 and the image guide 19 are integrated into the insertion unit 3. The insertion unit 3 is also detachably coupled to the light source device 2 and the optical detection device 4. An optical amplification unit 21 and a photoelectric converter 23 are integrated into the optical detection device 4. The frame sequential filter 13 is fixed to a filter driver unit 14 and rotated in accordance with the movement thereof. The optical amplification unit 21 is fixed to a driver unit 22 for optical amplification unit and rotated in accordance with the movement thereof.

A photoelectric converter 23 is connected to a driver unit 24 for the photoelectric converter and is driven by electric current generated at the driver unit 24. The image generator unit 5 is connected to the photoelectric converter 23 and converts an electric signal generated at the photoelectric converter 23 into an image signal by image processing. A not shown image memory for storing a series of obtained image signals is also integrated into the image generator unit 5. The image display unit 6 is connected to the image generator unit 5 and displays the image signal generated at the image generator unit 5.

The image generator unit 5, the image display unit 6, the light source driver unit 11, the filter driver unit 14, the driver unit 22 for the optical amplification unit and the driver unit 24 for the photoelectric converter are connected to the control unit 7 and are operationally controlled by the electric signals generated at the control unit 7.

Now, the light source device 2 is described in detail. The light source device 2 comprises the excitation light source 12, the frame sequential filter 13 and the frame sequential filter driver unit 14 and a condenser lens 15.

The excitation light source 12 generates excitation light by a xenon lamp, a halogen lamp, an LED, and LD (semiconductor laser) and the like. The excitation light source 12 is also coupled to the light source driver unit 11 which is connected to the control unit 7 and controls electric current, temperature, output light intensity and illumination duration by means of driving signals generated at the control unit 7. The frame sequential filter 13 is inserted between the excitation light source 12 and the condenser lens 15, and rotatably fixed to a rotational axis of the frame sequential filter driver unit 14 and controlled the rotation thereof at a predetermined speed by the control unit 7. The condenser lens 15 images the excitation light from the excitation light source 12 on a rear end face of the light guide 16 of the insertion unit 3.

As shown in FIG. 2, the frame sequential filter 13 comprises a set of three filters 30 in the inner circumference and a set of three filters 31 in the outer circumference forming a double structure. The whole frame sequential filter 13 is moved to be arranged on an illumination light path to selectively move either the first filter set 30 in the inner circumference or the second filter set 31 in the outer circumference of the frame sequential filter shown in FIG. 2 onto an optical axis connecting the excitation light source 12 and the rear end face of the light guide 16 by means of a not shown switching mechanism for the frame sequential filter. In a normal light observation mode, the frame sequential filter 13 is arranged to adjust the filter set 30 in the inner circumference on the light path from the excitation light source 12 and in a fluorescence observation mode, it is arranged to adjust the filter set 31 in the outer circumference on the same light path.

As shown in FIG. 2, the first filter set 30 in the inner circumference of the frame sequential filter 13 comprises generally three filters R, G and B for the optical observation mode, namely, filters 30R, 30G and 30B having a spectral property of transmitting a wavelength range of red (R), green (G) and blue (B). The second filter set 31 in the outer circumference comprises three filters 31A, 31B, 31C of spectral properties EX1, EX 2, EX 3 for the fluorescence observation mode. The filters 30R, 30G and 30B as well as filters 31A, 31B and 31C comply with exposure duration of the photoelectric converter 23 and light shields provided between respective filters comply with light shielding duration (reading duration) of the photoelectric converter 23. While filters 30R, 30 G, 30B are internally provided and the filters 31A, 31B, 31C are externally provided in FIG. 2, they can be arranged in an opposite manner. While the second filter set 31 in the outer circumference comprises three filters 31A, 31B, 31C of spectral properties EX1, EX 2, EX 3 for the fluorescence observation mode, it is also possible to provide less than three or more than three filters.

Now, the insertion unit 3 is described in detail. The insertion unit 3 has an elongate shape to be inserted into a body cavity of a patient. The insertion unit 3 comprises a light guide 16, an illumination lens 17, objective lens 18 and an image guide 19. The insertion unit 3 is flexibly formed for a digestive tract, a bronchial tube, head and neck (throat) and a bladder and rigidly formed for an abdominal cavity, a chest cavity and a uterus.

The light guide 16 guides the excitation light from the light source device 2 to a tip of the insertion unit 3. The illumination lens 17 is mounted on the tip of the insertion unit 3 and arranged on the end face of the light guide 16. The excitation light guided from the light source device 2 by the light guide 16 is irradiated on the object via the illumination lens 15. The objective lens 18 images the light from the object onto the tip of the image guide 19. The image guide 19 guides the light imaged by the objective lens 18 to an optical detection device 4.

Now, the optical detection device 4 is described in detail. The optical detection device 4 comprises a collective lens 20, an optical amplification unit 21, a driver unit 22 for the optical amplification unit 21 and a photoelectric converter 23.

The collective lens 20 images the light coming from the object and transmitted the insertion unit 3 into the photoelectric converter 23. The optical amplification unit 21 is inserted between the collective lens 20 and the photoelectric converter 23 and rotatably fixed to a rotational axis of the driver unit 22 for the optical amplification unit 21 and controlled the rotation at a predetermined speed by the control unit 7. The photoelectric converter 23 converts the light intensity of a CCD, CMOS, PD, APD, PTM and the like arranged in an imaging position of the collective lens 20 into an electric signal. The photoelectric converter 23 is arranged in a vertical viewing position in FIG. 1, but arrangement in a lateral viewing position or a perspective viewing position is also possible. The photoelectric converter 23 is also coupled to the photoelectric converter driver unit 24 to perform an electronic shutter control, an accumulation of signal charge and a sensitivity control. The photoelectric converter 23 is further connected to the image generator unit 5 for reading.

As shown in FIG. 3, the optical amplification unit 21 comprises three aperture set 32 in the inner circumference and three optical amplifier set 33 in the outer circumference forming a double structure. The aperture set 32 comprises apertures 32R, 32G and 32B. The optical amplifier set 33 comprises optical amplifiers 33A, 33B and 33C. The whole optical amplification unit 21 is moved to be arranged on a detection light path to selectively move either the aperture set 32 in the inner circumference or the optical amplifier set 33 in the outer circumference of the optical amplification unit 21 shown in FIG. 3 onto an optical axis of the detection light from the object, which connects the rear end face of the image guide 19 and the photoelectric converter by means of a not shown switching mechanism for the optical amplification unit. In the normal light observation mode, the optical amplification unit 19 is arranged to adjust the aperture set 32 in the inner circumference on the detection light path from the rear end face of the image guide and in the fluorescence observation mode, it is arranged to adjust the optical amplification set 33 in the outer circumference on the similar detection light path.

As shown in FIG. 3, the aperture set 32 in the inner circumference of the optical amplification unit 21 is used for the normal light observation mode and comprises apertures, through which the detection light emitted from the object and having a wavelength range of red (R), green (G) and blue (B) passes. The apertures 32R, 32G, 32B comply with exposure duration of the photoelectric converter 23 and light shields provided between respective apertures comply with light shielding duration (reading duration) of photoelectric converter 23. That is to say, the apertures 32R, 320, 320 corresponds to the filters 30R, 300, 30B of the first filter set 30 for the normal observation mode in the inner circumference of the frame sequential filter 13 as shown in FIG. 2 and is controlled by the control unit 7 with respect to their speed of rotation and synchronicity. The optical amplifier set 33 on the outer circumference of the optical amplification unit 21 comprises three optical amplifiers 33A, 33B, 33C corresponding to fluorescence FL1, FL2, FL3 having spectral properties for the fluorescence observation mode. The optical amplifiers 33A, 33B, 33C comply with exposure duration of the photoelectric converter 23 and light shields provided between respective optical amplifiers comply with light shielding duration (reading duration) of the photoelectric converter 23. That is to say, the optical amplifiers 33A, 33B, 33C corresponds to the filters 31A, 31B, 31C of the second filter set 31 for the fluorescence observation mode in the outer circumference of the frame sequential filter and is controlled by the control unit 7 with respect to their speed of rotation and synchronicity. While apertures 32R, 32 G, 32B are internally provided and the optical amplifiers 33A, 33B, 33C are externally provided in FIG. 3, they can be arranged in an opposite manner as in the case of the frame sequential filter 13. In the optical amplification unit 21, a not shown mode adjusting means for adjusting each mode status of fluorescence FL1, FL2, FL3 coming from the object and incident on the optical amplification unit 21 can be also arranged upstream of the optical amplifier 33A, 33B, 33C.

As shown in FIG. 4A and FIG. 4B, the optical amplifier 33A comprises excitation light sources 40A, 40B for the optical amplifier, a dichroic mirror 41, a band pass filter 42 and an optical amplification medium 43. The excitation light sources 40A, 40B comprise LED, LD and the like and are arranged on a surface of the optical amplification medium 43 as well as on a periphery of the optical amplifier 33A to generate excitation light for the optical amplifier. The excitation light sources 40A, 40B for the optical amplifier are coupled to a driver unit for the optical sources connected to the not shown control unit and supplied with electric current for illumination. The dichroic mirror 41 is arranged substantially parallel to the band pass filter 42 across the optical amplification medium 43 on the surface of the optical amplification medium 43, on which the light from the object is incident. As shown in FIG. 5, the dichroic mirror 41 has a spectral property of reflecting the light in a wavelength range of excitation light EXA of the optical amplifier and transmitting the light in a wavelength range longer than the fluorescence (incident fluorescence) FL 1 from the object. The band pass filter 42 is arranged substantially parallel to the dichroic mirror 41 across the optical amplification medium 43 on the surface of the optical amplification medium 43, from which amplified light FLA of the fluorescence FL1 from the object is irradiated. As shown in FIG. 5, the band pass filter 42 has a spectral property of reflecting light in a wavelength range of excitation light of the optical amplifier EXA and extracting as well as transmitting the light in a wavelength range narrower than that of incident fluorescence FL 1.

As shown in FIG. 4B, the excitation light of the light amplifier EXA generated by the amplification light sources 40A, 40B for the optical amplifier is repeatedly reflected between the dichroic mirror 41 and the band pass filter 42 to excite the optical amplification medium 43. The optical amplification medium 43 comprises materials such as glass, semiconductor, organic compounds and the like. The optical amplification medium 43 has a property of amplifying the fluorescence from the object in such a way that a part of the electrons forming the optical amplification medium 43 is excited due to the light absorption by the excitation light EXA generated at the amplification light sources 40A, 40B of the optical amplifier so that an energy relaxation process is coupled with the fluorescence FL1 coming from the object and is incident on the optical amplification medium 43. The band pass filter 42 has a property of reflecting noisy light having a wavelength range except for the fluorescence FLA coming from the object and amplified by the optical amplification medium 43. An amplification light source 40A and an amplification light source 40B for the optical amplifier are provided in FIG. 4A, the number of the amplification light sources 40A, 40B are not limited to this. While the light source 40A, 40B for the optical amplifier are arranged adjacent to the optical amplification medium 43 in FIG. 4B, it can be arranged in a non-contacting manner with the optical amplification medium 43 which is then irradiated with the excitation light EXA for the optical amplifiers.

Now, usage of the endoscope device 1 according to the first embodiment is described.

When endoscopy is started, a surgeon connects an insertion unit 3 of a type corresponding to an observation part, out of a plurality of endoscopes with the light source device 2 and the optical detection device 4. Thereby, various data with respect to the insertion unit 3 contained in the image generator unit 5 is read by the control unit 7. Then, the frame sequential filter 13 and the optical amplification unit 21 to be used, having a respective wavelength for the normal light mode and a specific light mode (fluorescence observation) in accordance with the type of insertion unit, which is one of various data, are determined and correction setting for light detection, conversion and reading of the photoelectric conversion unit 23 is adjusted.

Now, effects of the normal light mode and the specific light mode (fluorescence observation) are described.

A surgeon inserts the insertion unit 3 into a body cavity of a patient such as bronchial tube, digestive tract, stomach, large intestine, abdominal cavity, bladder and uterus and the like for observation.

If the normal light observation (normal light mode) is performed, the frame sequential filter 13 is arranged on the illumination light path with the first filter set 30. The excitation light excited from the excitation light source 12 is transmitted by the filter set 30, resulting in the light of R(red), G(green) and B(blue) of the illumination light of the frame sequential filter being irradiated on the object, in this case, the vital tissue, from the illumination lens 17 via the light guide 16 of the insertion unit 3 in time series. If the normal light observation is performed, the optical amplification unit 21 is arranged to adjust the aperture set 32 on the light path from the object. The light is sequentially irradiated on the object in time series and the light coming from the object pass through aperture set 32 in the optical amplifier 21, so that the light from the object is incident on the photoelectric converter in a sequence of R(red), G(green), B(blue) in time series. The driver unit 24 for the photoelectric converter controls each exposure duration and the charge storage time of the reflected light from R, G, B at the photoelectric conversion 23 based on a synchronous signal of R, G, B in the normal light mode, which is input from the control unit 7.

If the fluorescence observation (specific light mode) is performed, the surgeon selects the specific light mode (for fluorescence observation) by switching from the normal light mode by means of an observation mode switching means. Following the selection of the mode, the second filter set 31 of the frame sequential filter 13 is arranged on the illumination light path by the frame sequential filter switching means. Further, following the selection of the mode, the optical amplifier set 33 of the optical amplifier unit 21 is arranged on the light path of the light coming from the object by the optical amplifier switching unit 21. The excitation light irradiated from the excitation light source 12 is transmitted by the filter set 31, resulting in the frame sequential illumination lights corresponding to EX1, EX2, EX3 being irradiated on the vital tissue in time series via the illumination lens 17 through light guide 16 of the insertion unit 3. The frame sequential illumination light is irradiated on the object in a sequence of EX1, EX2, EX3 during the fluorescence observation so that fluorescence having spectral characteristics of FL1, FL2, FL3 is accordingly generated from the object. For the fluorescence observation, the optical amplifier set 33 of the optical amplifier unit 21 is arranged on the light path from the object. The fluorescence FL1, FL2, FL3 from the object is incident on the optical amplifier set 33 of the optical amplifier unit 21 and is transmitted by the optical amplifiers 33A, 33B, 33C, respectively, so that the fluorescence from each object is amplified in a sequence of a narrow wavelength range FLA, FLB, FLC extracted from the wavelength range of incident fluorescence FL1, FL2, FL3 corresponding to the spectral property of the optical amplifiers 33A, 33B, 33C, and is sequentially incident on the photoelectric converter 23. The intensity of the autofluorescence is very weak relative to the intensity of the reflected light and the intensity ratio of the fluorescence and the reflected light is different depending on the parts of the object. The control unit 7 changes the intensity ratio of the fluorescence and the reflected light, which is different depending on the part of the object and the wavelength, as well as the light intensity of the excitation light source and the gain of the optical amplifier unit 21 to an adequate value, so that the display of the image display 6 unit is kept constant. The reflected light of the excitation light itself due to the irradiation of the excitation light onto the object (for example, EX1) and the autofluorescence (for example FL1) emitted from the object due to the excitation light are incident on the optical amplification unit 21. However, the excitation light itself (for example EX1) is cut by the dichroic mirror 41 and only the autofluorescence (for example FLA) amplified by the optical amplification unit 21 is incident on the light detection surface of the photoelectric converter 23. The mode adjustment means is arranged on the optical amplification unit 21 to modulate the optical amplification unit 21 in such a manner that the optical amplification unit 21 allows the multi-mode fluorescence to be incident on an incident side of the mode adjustment means and the energy distribution mode with high consistency substantially corresponding to amplifying spatial mode of the optical amplifiers 30A, 33B, 33C can be achieved downstream of the optical amplifier unit 21 on an exit side. Thus, the light from the object can be collected at high efficiency even though it is fluorescence. Therefore, the optical amplification unit 21 can amplify the fluorescence FL1, FL2, FL3 from the object with low loss.

The fluorescence and the reflected light from the object are sequentially incident on the photoelectric converter 23. The output signal corresponding to each wavelength from the photoelectric converter 23 is input into the image generation unit 5 in which signal processing and memorizing are performed and the fluorescence image is displayed at the image display unit 6 and a peripheral device such as a personal computer. A white balance adjustment at imaging of the fluorescence and the reflected light, a conversion of a setting value in the observation mode and a color conversion process and the like are performed at the image generation unit 5.

The autofluorescence having a peak in a green range can be obtained when the excitation light in a blue range is irradiated on the mucosa, and a characteristic that the intensity strength of the autofluorescence in an affected region is smaller than that of the normal region is used for the fluorescence observation. Furthermore, by means of the effect of blood, i.e., hemoglobin absorption wavelength band capturing a green reflected light and a red reflected light as reference light (a wavelength range unaffected by the blood), a composite image that can be obtained by imaging a part of the observation object is an image, in which the presence of an affected region without the influence of the inflammation (blood) can be acutely detected. For example, inflammation or hyperplasia is displayed with the same color as normal tissues and a part of adenoma or cancer is displayed with a different color from that of normal tissues. Thus, finding the affected neoplastic region is easier relative to the normal observation.

According to the first embodiment, overlapping of the wavelength ranges of the fluorescence from a plurality of objects can be avoided by the optical amplification unit 21, so that the difference of various autofluorescent materials in a fluorescent image can be imaged. Moreover, the intensity of fluorescence decreased by the extraction of the wavelength can be optically amplified with a good S/N ratio, so that presence of affected region can be acutely detected with less noise such as roughness and adequate lightness even though imaging with high sensitivity is performed.

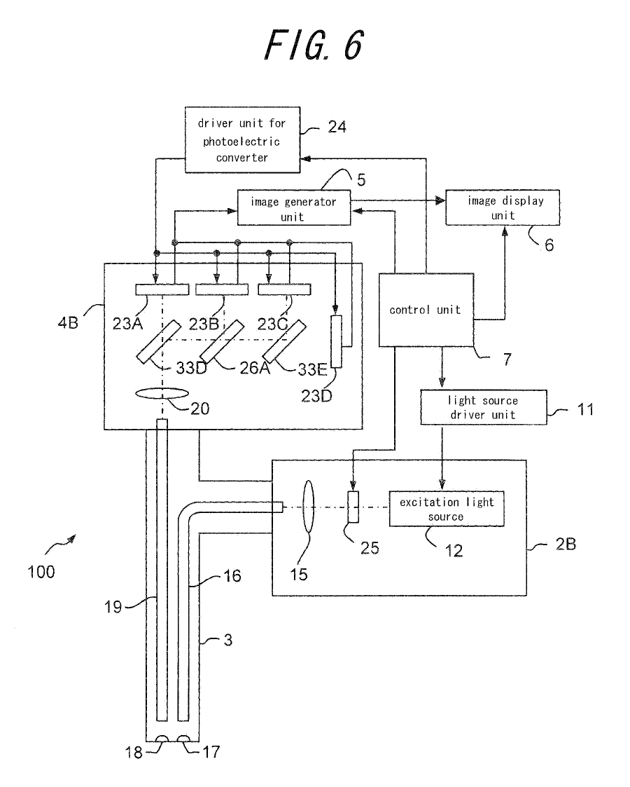

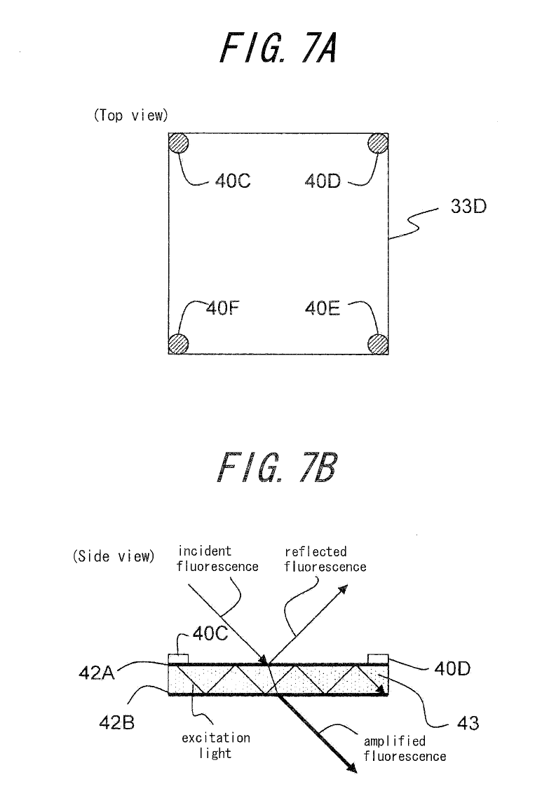

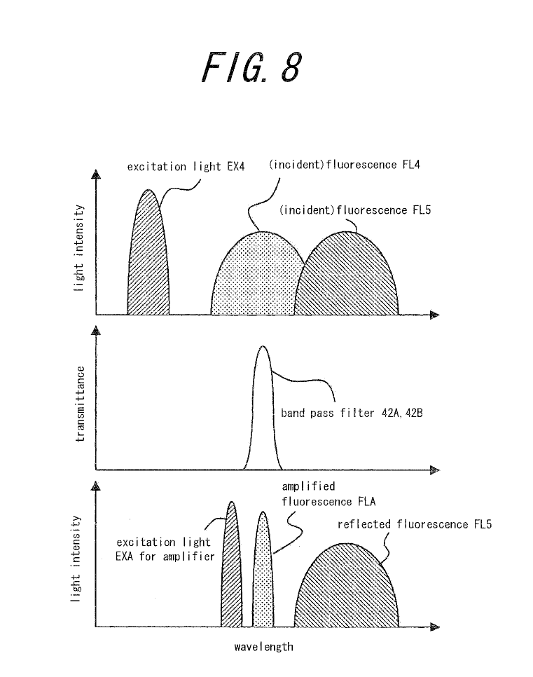

The second embodiment: FIGS. 6 to 8 are related to the second embodiment. FIG. 6 is a block diagram showing a schematic configuration of the endoscope device; FIG. 7A and FIG. 7B are a top view and a side view of the optical amplification unit, respectively; FIG. 8 is a graph showing spectral properties of the light source device and the optical amplification unit in fluorescence observation.

In the description of the second embodiment of the invention shown in FIGS. 6 to 8, the same components as the first embodiment shown in FIGS. 1 to 5 are given the same reference numerals and are not further described in detail.

Configuration: as shown in FIG. 6, the endoscope device 100 according to the second embodiment is newly provided with an excitation light filter 25 while the frame sequential filter 13 and the filter driving unit 14 are omitted in the optical source device 2B and also newly provided with a band pass filter 26A, a plurality of different optical amplifiers 33D, 33E and photoelectric converters 23A, 23B, 23C, 23D while the optical amplification unit 21 and optical amplification driver 22 are omitted in the optical detection device 4B.

The excitation light source 12 generates white excitation light by xenon lamp, halogen lamp, LED, LD (semiconductor laser) and the like. The excitation light filter 25 is a filter having a spectral property EX4 in the fluorescence observation mode and is interposed between the excitation light source 12 and the condenser lens 15. The excitation filter 25 is selectively moved onto the optical axis of the illumination light connecting the excitation light source 12 and the rear end face of the light guide 16 by a not shown switching mechanism for the excitation light filter. The excitation filter 25 is arranged outside of the illumination light path from the excitation light source 12 in the normal observation mode, and is arranged on the light path in the fluorescence observation mode. The excitation filter 25 can be a light amplifier.

In the fluorescence observation mode, the fluorescence FL4, FL5 from the object having a different wavelength range exits from the image guide 19 and is incident on the optical detection device 4B, and thereafter incident on the optical amplifier 33D. The optical amplifier 33D has a spectral property of amplifying the light intensity in the wavelength range of the fluorescence FL4 from the object and reflecting the light in the wavelength range of fluorescence FL5 from the object having a wavelength range different from the excitation light EX4 reflected on the object and the fluorescence FL4 from the object. The optical detection device 23A detects only the fluorescence FL4 coming from the object and amplified after transmitting the optical amplifier 33D. The band path filter 26A has a spectral property of transmitting the light in the wavelength range of fluorescence FL5 from the object. The optical amplifier 33E has a spectral property of amplifying the light intensity in the wavelength range of the fluorescence FL5 from the object. The optical detection device 23D detects only the fluorescence FL5 coming from the object and amplified after transmitting the optical amplifier 33E.

In the normal observation mode, the white detection light from the object exits from the image guide 19 and is incident on the optical detection device 4B, and thereafter it is incident on the optical amplifier 33D. The optical amplifier 33D has a spectral property of transmitting the light in the wavelength range of the detected light G (green) from the object and reflecting the light in the wavelength range of R (red) and B (blue). The band pass filter 26A has a spectral property of transmitting the light in the wavelength range of the detected light R (red) from the object, which is reflected at the optical amplifier 33D and reflecting the light in the wavelength range of B (blue). The optical amplifier 33E has a spectral property of reflecting the light in the wavelength range of the detected light R (red) from the object after the transmission of the band pass filter 26A. The photoelectric converters 23A, 23B, 23C detect the light G (green), B (blue), R (red) from the object, respectively.

As for the respective photoelectric converters 23A to 23 D, the band pass filter 26A and the optical amplifiers 33D, 33E, position, spectral property and the number of positioning are not limited to this.

As shown in FIGS. 7A and 7B, the optical amplifier 33D comprises light sources 40C, 40D, 40E, 40F for the optical amplifiers, band pass filters 42A, 42B and the optical amplification medium 43. A band pass filter 42A is arranged substantially parallel to the band pass filter 42B across the optical amplification medium 43 on the surface of the optical amplification medium 43, on which the fluorescence FL4 from the object is incident. As shown in FIG. 8, the band pass filter 42A has a spectral property of reflecting the light in the wavelength range of excitation light EXB for the light amplifier, the light in the wavelength range of the excitation light EX4 and the light in the wavelength range of the FL5 from the object, and extracting and transmitting the light in a wavelength range narrower than the wavelength range of the fluorescence FL4 from the object. The band pass filter 42B has a spectral property of reflecting the light in the wavelength range of the excitation light EXB for the light amplifier and extracting and transmitting the light FLB in a wavelength range narrower than the wavelength range of the fluorescence FL4 coming from the object and amplified by the light amplifying medium 43. The band pass filter 42B has a spectral property of reflecting noisy light having a wavelength range other than the fluorescence FLB coming from the object and amplified by the optical amplification medium 43.

Now, usage of the endoscope device 100 according to the second embodiment is described. The surgeon inserts the insertion unit 3 into a body cavity of a patient for observation.

For the normal light observation, the white illumination light is irradiated on the vital tissue, which is an object, by the excitation light source 12 via the light guide 16 of the insertion unit 3. The white illumination light is irradiated on the object and the white detection light from the object is transmitted the optical amplifier 33D, the band pass filter 26A, and the optical amplifier 33E, so that the light G (green), B (blue), R(red) are incident on the photoelectric converter, respectively.

For the fluorescence observation, the excitation light having a wavelength range of the excitation light EX 4 is illuminated from the white light of the excitation light source 12 via the excitation filter 25 and irradiated on the vital tissue through the light guide 16 of the insert unit 3 and the illumination lens. Fluorescence FL4, FL 5 from the object passes the optical amplifier 33D, 33E, respectively and is extracted and amplified in a wavelength range FLB, FLC narrower than the fluorescence FL4, FL 5. Each amplified fluorescence FLB, FLC from the object is incident on the photoelectric converter.

According to the second embodiment, overlapping of the wavelength ranges of the fluorescence from a plurality of objects can be avoided by the optical amplifiers 33D, 33E, so that the difference of various autofluorescent materials in a fluorescence image can be imaged. Moreover, the intensity of fluorescence decreased by the extraction of the wavelength can be optically amplified with a good S/N ratio, so that presence of affected region can be acutely detected with less noise, such as roughness and adequate lightness and rapidly relative to the first embodiment even though imaging with high sensitivity is performed.

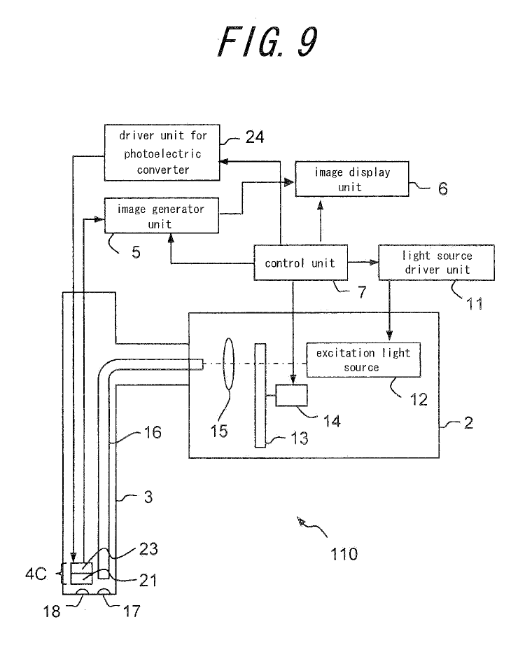

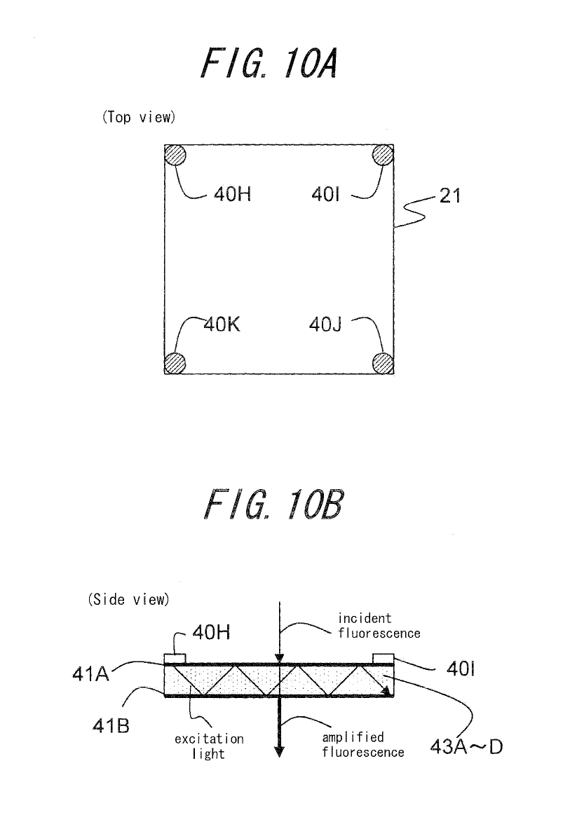

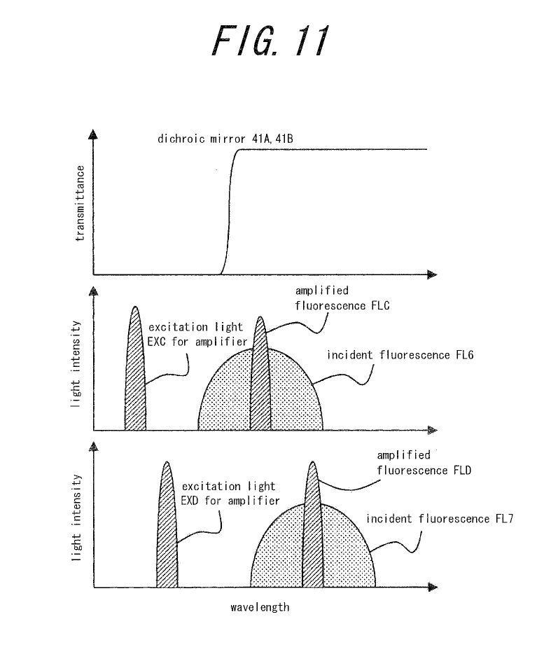

The third embodiment: FIGS. 9 to 11 are related to the third embodiment of the invention. FIG. 9 is a block diagram showing a schematic configuration of the endoscope device; FIG. 10A and FIG. 10B are a top view and a side vie of optical amplification unit, respectively; FIG. 11 is a graph showing spectral properties of the light source device and the optical amplification unit in fluorescence observation.

In the description of the third embodiment of the invention shown in FIGS. 9 to 11, the same components as the first embodiment shown in FIGS. 1 to 5 and the second embodiment shown in FIGS. 6 to 8 are given the same reference numerals and are not further described in detail.

Configuration: As shown in FIG. 9, the endoscope device 110 according to the third embodiment is different from the first embodiment shown in FIGS. 1 to 5 in that the image guide 19 is omitted and the optical amplification unit 21 and the photoelectric converter 23 are integrated into the optical detection device 4C, which then is arranged on the tip of the insertion unit 3C.

The objective lens 18 is mounted on the tip of the insertion unit 3C and provided on the side of the optical amplification unit 21 of the optical detection device 4C. The light from the object is imaged on the photoelectric converter 23 by the objective lens 18. The optical detection device 4C comprises the optical amplification unit 21 and the photoelectric converter 23 attached to each other and arranged on the tip of the insertion unit 3C with a surface of the optical amplification unit 21 and the objective lens 18 facing to each other. The photoelectric amplifier 23 is an element which converts the light intensity of a CCD, CMOS and the like provided in an imaging position of the objective lens 18 into an electric signal.

As shown in FIG. 10A, 10B, the optical amplification unit 21 comprises light sources 40H, 40I, 40J, 40K for the optical amplifiers, dichroic mirrors 41A, 41B and optical amplification media 43A, 43B, 43C, 43D. Each of the optical amplification unit 21 and the photoelectric converter 23 comprises not shown elements. The photoelectric amplification unit 21 comprises an element having a spectral property of selectively transmitting the detection light R (red), G (green), B (blue) from the object during the normal light observation. The optical amplification unit 21 also comprises an element having a spectral property of amplifying fluorescence FL6, FL7 from the object corresponding to the excitation lights EX6, EX7 for the object during the fluorescence observation. That is to say, as for the optical amplification unit 21, the element having a spectral property for the normal observation mode corresponds to the first filter set 30 in the inner circumferential part of the frame sequential filter in FIG. 2, while the element for the fluorescence observation corresponds to the second filter set 31 in the outer circumferential part of the frame sequential filter 13. The control unit 7 controls lighting and synchronicity of the excitation light source 40H, 40I, 40J, 40K for the light amplification. The not shown element of the optical amplification unit 21 comprises the excitation light source 40H and the optical amplification medium 43A for the optical amplification, extracting and amplifying the wavelength range narrower than the light of the wavelength range of the fluorescence FL6 from the object. The not shown element of the optical amplification unit 21 comprises the excitation light source 40I and the optical amplification medium 43B for the optical amplification, extracting and amplifying the wavelength range narrower than the light of the wavelength range of the fluorescence FL7 from the object. The excitation light source 40H, 40I, 40J, 40K for the light amplification are arranged in the periphery of the light amplification unit 21. However, many light sources can be arranged for each element.

As shown in FIG. 11, the dichroic mirrors 41A, 41B have a spectral property of reflecting the light in a wavelength range of the excitation light of the optical amplification and transmitting the light in the wavelength range longer than the fluorescence from the object. A band pass filter can be used for the dichroic mirror 41B. The dichroic mirrors 41A, 41B cover the optical amplification unit 21 in an integrated manner. However they can be provided for each element corresponding to the spectral property of fluorescence from the object.

Now, usage of the endoscope device 110 according to the third embodiment is described. The surgeon inserts the insertion unit 3C into a body cavity of a patient for observation.

For the normal light observation (normal light mode), the first filter set 30 of the frame sequential filter 13 shown in FIG. 2 are arranged on the illumination light path. The excitation light from the excitation light source 12 is transmitted by the fitter set 30, resulting in the light of R(red), G(green) and B(blue) of the illumination light of the frame sequential filter being irradiated on the object, in this case, the vital tissue, via the illumination lens 17 through the light guide 16 of the insertion unit 3C in time series. Furthermore, the frame sequential lights are irradiated on the object in time series and the lights from the object pass through in the optical amplifier 21, so that the lights from the object are incident on the photoelectric converter in a sequence of R (red), G (green), B (blue) in time series.

If the fluorescence observation (specific light mode) is performed, the surgeon selects the specific light mode (for fluorescence observation) by switching from the normal light mode at an observation mode switching unit. Following the selection of the mode, the second filter set 31 of the frame sequential filter 13 are arranged on the illumination light path by the frame sequential filter switching unit. The excitation light irradiated from the excitation light source 12 is transmitted by the filter set 31, resulting in the excitation light EX6, EX7 of the illumination light of the frame sequential filter being irradiated on the vital tissue in time series via the illumination lens 17 through light guide 16 of the insertion unit 3. The frame sequential illumination light is irradiated on the object in a sequence of EX6, EX7 during the fluorescence observation, so that fluorescence having a spectral property of FL6, FL7 is accordingly generated. For the fluorescence observation, the light amplification unit 21 sequentially lights up the excitation light sources 40H, 40I for the light amplifiers. Each of the light FL6, FL7 from the object is transmitted respective element of the optical amplification unit 21, so that the light from the object is extracted and amplified in time series in a wavelength range FLC, AFD narrower than the wavelength range of the incident fluorescence in accordance with the spectral property of each element of the optical amplification unit 21 and is sequentially incident on the photoelectric converter 23.

According to the third embodiment, the difference of various autofluorescent materials in the excitation light image can be imaged and the fluorescence intensity decreased by the extraction of the wavelength can be optically amplified with a good S/N ratio, so that presence of affected region can be acutely detected by mounting an relatively cheep imaging element on the tip of the endoscope instead of an expensive imaging element with high sensitivity.

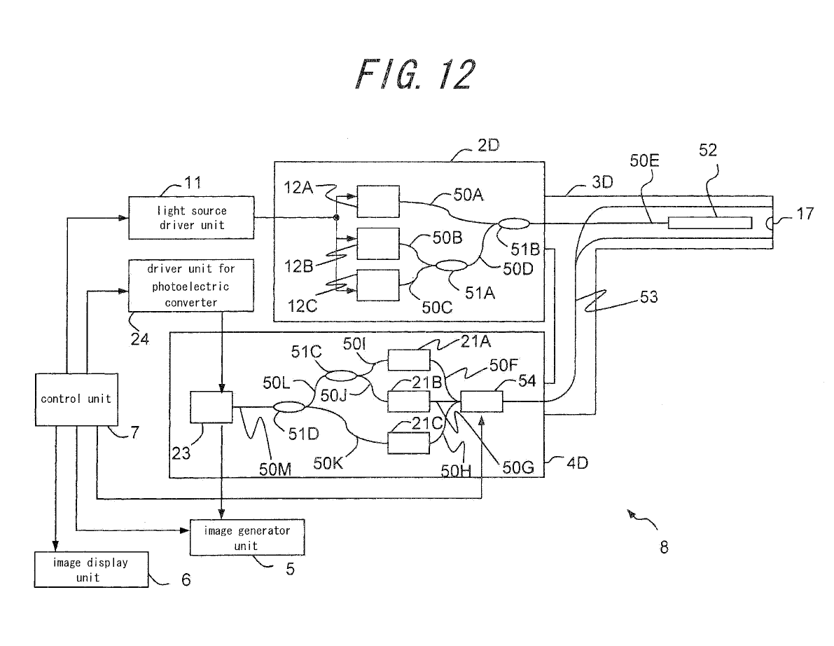

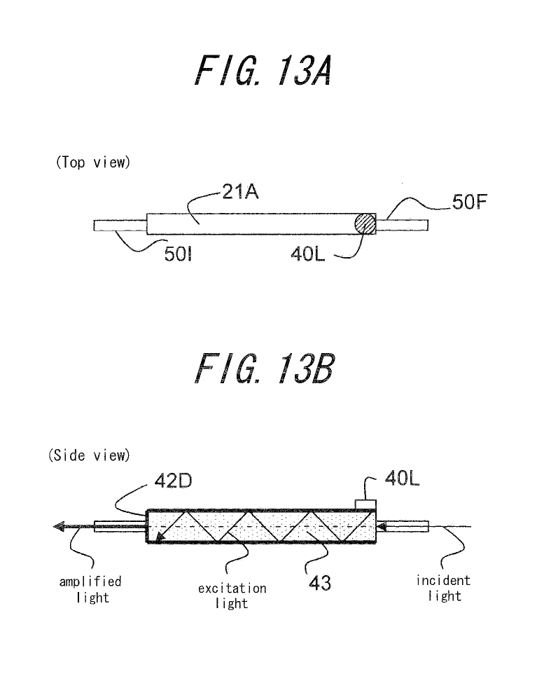

The fourth embodiment: FIGS. 12 and 13 are related to the fourth embodiment of the invention. FIG. 12 is a block diagram showing a schematic configuration of the scanning endoscope device; FIG. 13A is a top view of a scanning endoscope device; and FIG. 13B is a side view of an optical amplification unit.

In the description of the fourth embodiment of the invention shown in FIGS. 12 and 13, the same components as the first embodiment shown in FIGS. 1 to 5, the second embodiment shown in FIGS. 6 to 8 and the third embodiment shown in FIGS. 9 to 11 are given the same reference numerals and are not further described in detail.

Configuration: As shown in FIG. 12, the scanning endoscope device 8 according to the fourth embodiment is different from the first embodiment shown in FIG. 1 to FIG. 5 in that elements integrated in the light source device 2D, insertion unit 3D and the optical detection unit 4D and arrangement are changed.

Excitation light sources 12A, 12B, 12D, optical fibers 50A, 50B, 50C, 50D and optical couplers 51A, 51B are integrated into the light source device 2D. The illumination lens 17, an optical fiber 50E, an illumination scanning unit 52 and detection optical fiber 53 are integrated into the insertion unit 3D. The optical amplification units 21A, 21B, 21C, photoelectric converter 23, detection optical fibers 50F, 50G, 50H, 50I, 50J, 50K, 50L, 50M, optical couplers 51C, 51D and wavelength demultiplexer 54 are integrated into the optical detection device 4D.

Now, the light source device 2D is described in detail. Each of the excitation light sources 12A, 12B, 12C generates the excitation light consisting of LED, LD (semiconductor laser) and the like in the wavelength range of red (R), green (G), blue (B). The excitation light sources 12A, 12B, 12C are connected to the light source driver unit 11 and provided with electric current for lighting up. Furthermore, the light source driver unit 11 is connected to the control unit 7 to sequentially light up the excitation light source 12A, 12B, 12C by inputting a periodic signal from the control unit 7. Then the frame sequential illumination light of R (red), G(green), B(blue) is irradiated on the vital tissue through the illumination lens 17 via an optical scanning unit 52 of an insertion unit 3D and the like in time series. The optical fibers 50A, 50B, 50C guide the excitation light from the excitation light sources 12A, 12B, 12C to the optical couplers 51B, 51A, 51A, respectively, and the optical fiber 50D guides the excitation light from the light coupler 51A to the light coupler 51B. The optical coupler 51A outputs the excitation light of green (G) and blue (B) to the optical fiber 50D. The optical coupler 51B outputs the excitation light of green (G), blue (B), and red (R) to the rear end of the optical fiber 50E of the insertion unit 3D.

Now, the insertion unit 3D is described in detail. The optical fiber 50E guides the excitation light from the light source device 2D to the illumination scanning unit 52. The illumination scanning unit 52 comprises a light deflector such as a photoelectric element and a light deflection element such as acousto-optical element, as well as an optical fiber mechanically deformed by piezoelectric effect or electromagnetic force and the like, and deflects the excitation light from the optical fiber 50E. The illumination lens 17 is mounted on the tip of the insertion unit 3D and arranged on the side of the end face of the illumination scanning unit 52. The excitation light guided from the light source device 2 by the optical fiber 50E is deflected by the illumination scanning unit 52 and irradiated on the object via the illumination lens 17. The illumination scanning unit 52 is provided with electric current from a not shown driver unit for the illumination scanning unit and controlled thereby. The not shown illumination scanning driver unit is connected to the controller 7 and controlled by the electric signal generated at the control unit 7. Thus, the illumination scanning unit 52 scans the light irradiated on the object on the object surface by periodic drive by inputting the electric signal in a certain waveform from the control unit 7. The detection optical fiber 53 comprises a plurality of the optical fibers and is arranged from the tip to the rear end of the insertion unit 3 in the periphery of the insertion unit 3D. The detection optical fiber 53 receives the light from the object within an incident angle, which is determined by the structure and the composition of the optical fiber, from the tip of the optical fiber and guides it to the optical detection device 4D.

Now, the light source device 4D is described in detail. The optical fibers 50F, 50G, 50H guide the light of R (red), G (green), B (blue) from the wavelength demultiplexer 54 to the optical amplification units 21A, 21B, 21C, respectively; the optical fibers 50I, 50J, 50K guide the amplified light of R (red), G (green), B (blue) to the optical couplers 51C, 51C, 51D, respectively; the optical fiber 50L guides the amplified light R (red), G (green) to the optical coupler 51D; and the optical fiber 50M guides the amplified light of R (red), G (green), B (blue) to the photoelectric converter 23. The wavelength demultiplexer 54 comprises a diffraction grating and a light deflection element and the like and distributes the light incident on the detection optical fiber 53 to optical fiber 50F, 50G, 50H, respectively, depending on the wavelength range of R (red), G (green), B (blue). Furthermore, if the wavelength demultiplexer 54 comprises an active element such as a light deflection element, the wavelength demultiplexer 54 is connected to the control unit 7 and timing of the distribution of R (red), G (green), B (blue) is synchronized with the excitation light sources 12A, 12B, 12C by periodically inputting electric signals from the control unit 7. The optical coupler 51C outputs the light of R (red), G (green), B (blue) from the object to the optical fiber 50L. The optical coupler 51D outputs the light of R (red), G (green), B (blue) from the object to the optical fiber 50M. The photoelectric converter 23 is an element which converts the light intensity of PD, APD, PMT and the like into an electric signal.

As shown in FIG. 13A, 13B, the optical amplifier 21A comprises an excitation light source 40L for the optical amplifier, a band pass filter 42D and an optical amplification medium 43. The excitation light source 40L for optical amplifier is arranged on the surface of the optical amplification medium 43 and on an end of the optical amplification unit 21A. The excitation light source 40L for optical amplifier generates the excitation light for the light amplifier consisting of LED, LD and the like. The band pass filter 42D is arranged on the surface of the optical amplification medium 43 on the side of emitting the amplified light from the object. The excitation light for the light amplifier emitted at the excitation light source 40L for the optical amplifier is repeatedly reflected between both end faces in longitudinal direction of the optical amplification unit 21A and excites the optical amplification medium 43. The optical amplification medium 43 has a property of amplifying the light of R (red) from the object by the excitation light generated at the excitation light source 40L. The optical amplification units 21B, 21C have a property of amplifying light of G (green) and B (blue), respectively, in the same way as the optical amplification unit 21A.

Furthermore, if an excitation light source, optical fibers, optical couplers, a wavelength demultiplexer, optical amplification unit, and a switching unit for the observation modes are provided for the fluorescence observation as in the case of the normal observation, the fluorescence observation can be performed by switching from the normal observation mode to the fluorescence observation mode.

Now, usage of the scanning endoscope device 8 according to the fourth embodiment is described. The surgeon inserts the insertion unit 3D into a body cavity of a patient for observation.

For the normal observation, frame sequential lights of R (red), G (green) and B (blue) from the excitation light source 12A, 12B, 12C are irradiated on the object, in this case, the vital tissue, through the illumination lens 17 via the illumination scanning unit 52 of the insertion unit 3 in time series. Furthermore, the frame sequential illumination light is irradiated on the object in time series, so that the lights of R (red), G (green), B (blue) from the object pass through the optical amplification unit 21A, 21B, 21C, respectively, and amplified in time series, and the amplified lights of R (red), G (green), B (blue) are sequentially incident on the photoelectric converter 23 after transmitting.

According to the fourth embodiment, the intensity of the reflected excitation light, which is decreased due to rapid illumination scanning and narrow incident angle of the detection optical fiber, is amplified at a good S/N ratio, so that an image with less noise such as roughness and adequate lightness can be achieved.

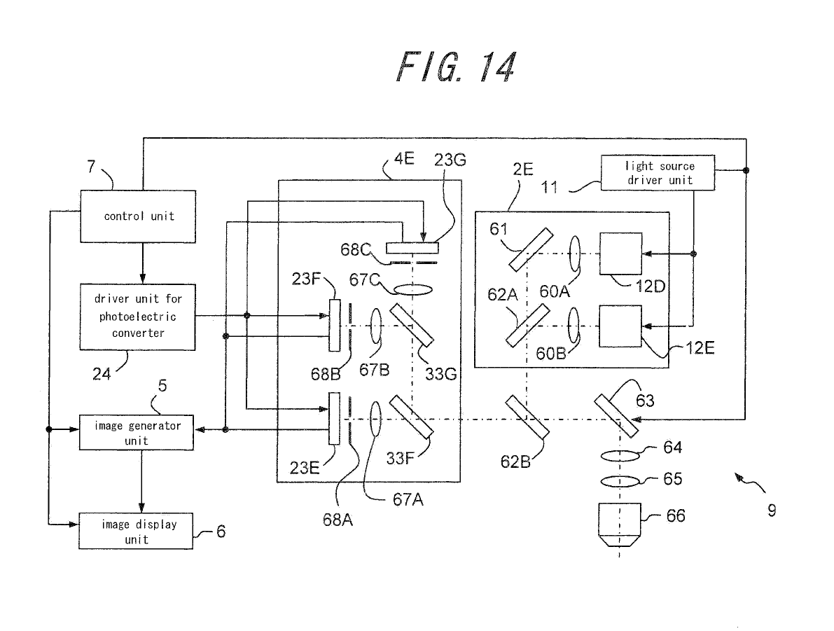

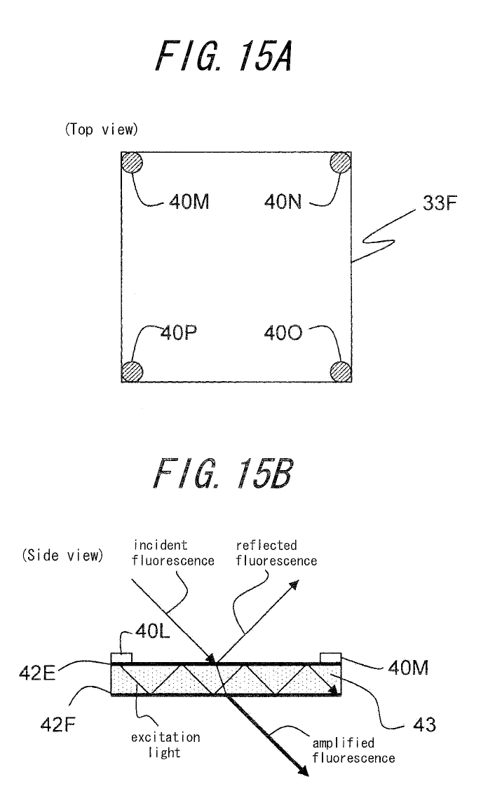

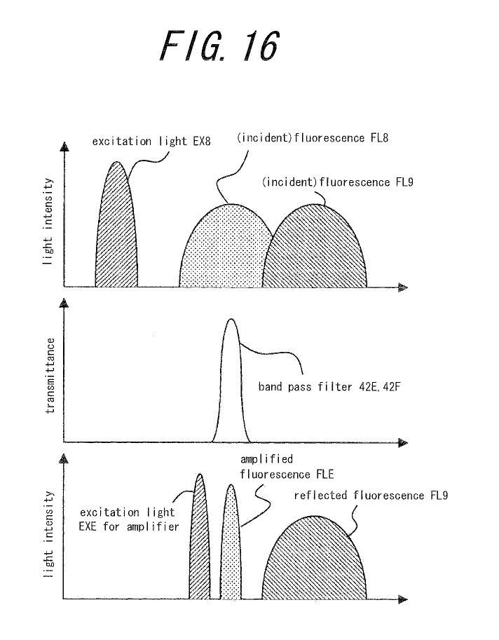

The fifth embodiment: The FIGS. 14 to 16 are related to the fifth embodiment of the invention; FIG. 14 shows a block diagram showing a schematic configuration of the scanning fluorescence microscope device; FIG. 15A is a top view of the optical amplification unit, FIG. 15B is a side view of an optical amplification unit; and FIG. 16 is a graph showing spectral property of the light source device and the optical amplification unit in fluorescence observation.

In the description of the fifth embodiment of the invention shown in FIGS. 14 to 16, the same components as the first embodiment shown in FIGS. 1 to 5, the second embodiment shown in FIGS. 6 to 8, the third embodiment shown in FIGS. 9 to 11, and the fourth embodiment shown in FIG. 12 or 13 are given the same reference numerals and are not further described in detail.

Configuration: As shown in FIG. 14, the main part of the scanning microscope device 9 in the fifth embodiment comprises a light source device 2E, an optical detection device 4E, an image display unit 6, a control unit 7, dichroic mirror 62B, an illumination scanning unit 63, a pupil objective lens 64, an image lens 65, and an objective lens 66.

The optical device 2E comprises an excitation light source 12D, 12E, collimator lenses 60A, 60B, mirror 61 and dichroic mirror 62A. Respective collimator lenses 60A, 60B substantially collimate the excitation light spread from the excitation light source 12D, 12E. The mirror 61 is interposed between the collimator lens 60A and the dichroic mirror 62A. The dichroic mirror 62A is disposed downstream of the collimator lens 60B at such an angle that the excitation light from the excitation light source 12D and the excitation light from the excitation light source 12E are coaxial. The dichroic mirror 62A also has a spectral property of transmitting the light in a wavelength range of the excitation light from the excitation light source 12C and reflecting the light in a wavelength range of the excitation light from the excitation light source 12E. The excitation light transmitted by and reflected at the dichroic mirror 62A exits the light source device 2E, and is incident on the dichroic mirror 62B.

The substantially parallel excitation light from the excitation light sources 12D, 12E exits the light source device 2E and is reflected at the dichroic mirror 62B and then passes the illumination scanning unit 63 and is transmitted and focused by the pupil objective lens 64. Then, the light is transmitted by the imaging lens 65 to be substantially parallel, and is subsequently transmitted by the objective lens 66 to be irradiated on a surface of the object. The illumination scanning unit 63 is supplied electric current form a not shown driver unit for an illumination scanning unit and controlled thereby. The illumination scanning unit 63 comprises a light deflector such as a photoelectric element and a light deflection element such as acousto-optical element, as well as a mirror mechanically deformed by piezoelectric effect or electromagnetic force and the like, and deflects the excitation light from the dichroic mirror 62. The not shown driver unit for an illumination scanning unit is connected to the control unit 7 and is controlled an electric signal generated at the control unit 7. Thus, the illumination scanning unit 63 is periodically driven by inputting the electric signal in any waveform from the control unit 7, so that it scans the excitation light irradiated on the object on the surface of the object. The objective lens 66 is arranged on an end of the scanning microscope device 9. The excitation light guided from the illumination light source 2 is deflected by the illumination scanning unit 63 and irradiated on the object via the objective lens 66.

The excitation light EX8 generated from the excitation light source 12D excites the fluorescent material in the object and emits fluoresce FL 8, FL9.

After the fluorescence FL8, FL9 from the object is collected at the objective lens 66 and exits as a substantially parallel light, and the light is transmitted and focused by the imaging lens 65, and the light is transmitted by the pupil objective lens 64 to be substantially parallel, and the light is subsequently transmitted by the dichroic mirror 62B and incident on the optical detection device 4E.

The optical detection device 4E comprises photoelectric converters 23E, 23F, 23G, optical amplifiers 33F, 33G, collective lenses 67A, 67B, 67C and confocal pinholes 68A, 68B, 68C. The substantially parallel fluorescence FL8, FL9 transmitted by the dichroic mirror 62B is incident on the light detection device 4E and then on the optical amplifier 33F. The optical amplifier 33F has a spectral property of amplifying the intensity of the light, extracted from the wavelength range of the fluorescence FL6 from the object, having a narrow wavelength range FLE, and reflecting the light having a wavelength range of the excitation light EX8 and the fluorescence FL9. Each of the confocal pinholes 68A, 68B, 68C has a not shown plurality of apertures with different diameter. The confocal pinholes 68A, 68B, 68C have a not shown driver unit for the confocal pinholes, the driver unit being connected to the control unit 7 (not shown), and selecting and arranging a diameter of the aperture of the confocal point by a control signal from the control unit 7. The collective lens 67A images the substantially parallel amplified fluorescence FLE onto the aperture of the confocal pinhole 68A. The confocal pinhole 68A is arranged in a conjugate position with the focusing point of the objective lens 66 and blocks scattered light and fluorescence generated around the focusing point of the objective lens 66 depending on the diameter of the aperture of the confocal pinhole. The photoelectric converter 23E detects only the amplified fluorescence FLE from the object, which has passed the aperture of the confocal pinhole 68A.

As shown in FIGS. 15A, 15B, the optical amplification unit 33F comprises excitation light sources 40M, 40N, 40O, 40P for the optical amplifiers, band pass filters 42E, 42F and an optical amplification medium 43. The band pass filter 42E is arranged substantially parallel to the band pass filter 42F across the optical amplification medium 43 on the surface of the optical amplification medium 43, on which the fluorescence FL8 from the object is incident. As shown in FIG. 16, the band pass filters 42E, 42F have a spectral property of reflecting the light in the wavelength range of the excitation light EXE for the optical amplifier and extracting and transmitting the light FLE of the wavelength range narrower than the wavelength range of the incident fluorescence FL8. The band pass filter 42E also has a spectral property of reflecting the light in the wavelength range of the excitation light EX8 incident on the object and the fluorescence FL9 emitted from the object and transmitting the light from the object within the wavelength of fluorescence FL8. The band pass filter 42F has a property of reflecting a noisy light having any wavelength range except for the wavelength range of fluorescence FLE from the object, which has been amplified by the optical amplification medium 43.

Now, usage of the scanning microscope device 9 according to the fifth embodiment is described. A user arranges an object on the stage for observation.

For the fluorescence observation, the excitation light from the excitation light sources 12D, 12E is irradiated on the object via the illumination scanning unit 63 from the objective lens 66. Each of the fluorescence FL8 and FL9 is amplified and reflected at the optical amplifier 33F, and the amplified fluorescence FLE from the object is transmitted the confocal pinhole 68A and incident on the photoelectric converter 23E. The fluorescence FL9 from the object is also reflected at the optical amplifier 33F and amplified at the optical amplifier 33G. Then the amplified fluorescence FLF (not shown) from the object passes the confocal pinhole 68C and is incident on the photoelectric converter 23G.

According to the fifth embodiment, overlapping of the wavelength ranges of the fluorescence from a plurality of objects can be avoided by the optical amplifier 33, so that the difference of various fluorescence materials in a fluorescence image can be imaged. Furthermore, the intensity of fluorescence decreased by the extraction of the wavelength can be optically amplified with a good S/N ratio, so that presence of the fluorescent material can be acutely detected with less noise, such as roughness and adequate lightness.

The invention is not limited to the above embodiments, but many variations and modifications are possible. For example, optical amplification unit 21 and the optical amplifier 33 comprise a band pass filter 42 for extracting the light in the wavelength range narrower than the wavelength range of the detection light of the fluorescence from the object in the first to the fifth embodiments, but may also comprise the optical amplification medium 43 generating less noisy light in the wavelength range except for the wavelength range in which the light in the wavelength range narrower than that of the detection light or the fluorescence from the object are extracted and amplified. As an effect obtained from this configuration, the wavelength range of the band pass filter 42 on the exit side of the detection light or the fluorescence from the object, which is amplified at the optical amplifier 33 and the optical amplifier 42, can be broadened.

The optical amplification unit 21 and the optical amplifier 33 comprise a spectral property of having a single wavelength range of the light extracted from the detection light and the fluorescence from each object in the first to the fifth embodiments, but may comprise a spectral property allowing variable wavelength range (bandwidth) to be extracted and variable wavelength. As an effect of this configuration, it is possible to amplify the light at the optical amplifier 33 and the optical amplifier 42 by extracting a constant wavelength range of the light narrower than the detection light and the fluorescence from the object and sweeping the center wavelength of the constant wavelength range for amplifying. That is to say, it is possible to amplify the light by resolving spectrum of the detection light and the fluorescence from the object, so that a spectrometer with good wavelength resolution capacity, detection sensitivity and S/N ratio can be realized.

Furthermore, the optical amplification unit 21 and the optical amplifier 33 have a responsive property of completing rising and falling of the light amplification within a half time of the exposure duration for each frame sequential illumination light R (red), G (green), B (blue) in the normal observation in the first to the fifth embodiments. Moreover, the optical amplification unit 21 and the optical amplifier 33 have a responsive property of completing rising and falling of the light amplification within a half time of the exposure duration for each excitation lights EX 1 to EX 8 in the fluorescence observation in the first to the fifth embodiments.

While the autofluorescence is described as an example for scattering light in the above embodiment, the invention it is not limited to the autofluorescence, but can be applied for optical detection or image observation by fluorescent agent (such as fluorescent probe, fluorescent dye) which is supplied by directly splaying on the observation object by a nozzle or localized on the observation object within a body by means of drug delivery technique.

### REFERENCE NUMERALS

1, 100, 110 endoscope device
2 light source device
3 insertion unit
4 optical detection device
5 image generator unit
6 image display unit
7 control unit
8 scanning endoscope device
9 scanning microscope device
11 light source driver unit
12 excitation light source
13 frame sequential filter
14 filter driver unit
15 condenser lens
16 light guide
17 illumination lens
18 objective lens
19 image guide
20 collective lens
21 optical amplification unit
22 driver unit for the optical amplification unit
23 photoelectric converter
24 driver unit for the photoelectric converter
30 RGB filter
31 excitation light filter
32 aperture
33 optical amplifier
40 excitation light source for optical amplifier
41 dichroic mirror
42 band pass filter
43 optical amplification medium
50 optical fiber
51 optical coupler
52 illumination scanning unit
53 detection optical fiber
54 wavelength demultiplexer
60 collimator lens
61 mirror
62 dichroic mirror
63 illumination scanning unit
64 pupil objective lens
65 imaging lens
66 objective lens
67 collective lens
68 confocal pinhole

What is claimed is:

1. A method for detecting optical spectrum, wherein optical spectrum of a light irradiated on an object, a spontaneous light emitted from within the object or a surface thereof, a scattered light, a transmitted light, a reflected light or a refracted light from within the object or a surface thereof generated by irradiating light on the object is resolved by amplifying said lights in a bandwidth narrower than the bandwidth of the optical spectrum of said lights.

2. The method for detecting optical spectrum according to claim 1, wherein the object is irradiated with the light amplified in the bandwidth narrower than the bandwidth of the optical spectrum of a light source; and the optical spectrum of the scattered light, the transmitted light, the reflected light or the refracted light from within the object or the surface thereof generated by irradiating light on the object are resolved and detected at a photoelectric converter.

3. The method for detecting optical spectrum according to claim 1, wherein the light spectrum of the scattered light, the transmitted light, the reflected light or the refracted light from within the object or the surface thereof generated by irradiating light on the object is resolved by amplifying said lights in a bandwidth narrower than the bandwidth of the optical spectrum of said lights and detected at the photoelectric converter.

4. The method for detecting optical spectrum according to claim 1, wherein the light spectrum of the spontaneous light irradiated from within the object or a surface thereof is resolved by amplifying said light in the bandwidth narrower than the bandwidth of the optical spectrum of said light and detected at the photoelectric converter.

5. The method for detecting optical spectrum according to claim 1, wherein the object is irradiated with the light amplified in the bandwidth narrower than the bandwidth of the optical spectrum of a light source; and the optical spectrum of the scattered light, the transmitted light, the reflected light or the refracted light from within the object or the surface thereof generated by irradiating light on the object is resolved by amplifying said lights in the bandwidth narrower than the bandwidth of the optical spectrum of said lights and detected at a photoelectric converter.

6. The method for detecting optical spectrum according to claim 2, wherein the light spectrum of the scattered light, the transmitted light, the reflected light or the refracted light from within the object or the surface thereof generated by irradiating light on the object is resolved by extracting a wavelength of said lights by means of a filter and detected at a photoelectric converter.

7. The method for detecting optical spectrum according to claim 2, wherein a wavelength of the light from the light source is extracted by the filter and the light with the extracted wavelength is irradiated on the object.

8. The method for detecting optical spectrum according to claim 1, wherein the wavelength of the amplified light is extracted by means of a filter and the light with the extracted wavelength is irradiated on the object or detected at the photoelectric converter.

9. The method for detecting optical spectrum according to claim 1, wherein the light irradiated on the object, the spontaneous light emitted from within the object or the surface thereof, the scattered light, the transmitted light, the reflected light or the refracted light from within the object or the surface thereof generated by irradiating light on the object is amplified after adjusting a mode.
